(19) United States
(12) Patent Application Publication
(10) Pub. No.: US 2006/0245823 A1
(43) Pub. Date: Nov. 2, 2006

(54) Axially adjusting device

(76) Inventors: Adrian Chludek, St Augustin (DE); Aleksej Katsnelson, St. Augustin (DE); Kurt Müller, Merzenich (DE)

Correspondence Address: ARTZ & ARTZ, P.C., 28333 TELEGRAPH RD., SUITE 250, SOUTHFIELD, MI, 48034, US

(21) Appl. No.: 10/562,563

(22) PCT Filed: Aug. 14, 2004
(86) PCT No.: PCT/EP04/09132

§ 371 Date: May 5, 2006

(30) Foreign Application Priority Data
Sep. 10, 2003 (DE) 230 14 141.5

(51) Int. Cl. B25G 3/18

(52) U.S. Cl. 403/322.3

(57) ABSTRACT

The invention relates to an axially adjusting device for actuating a multiple disk clutch in the drive train of a motor vehicle. Said adjusting device comprises a housing (4) with a longitudinal axis (A) and a ball ramp arrangement (1) having a support disk (17) that is axially and radially supported in the housing (4) and an axially displaceable adjusting disk (16). The supporting disk (17) is secured against rotation in the housing (4) and, in a first lateral face (23), has first ball tracks (24) of varying depth in the peripheral direction. The adjusting disk (16) can be rotatingly driven and, in a second lateral face (25) opposite the first lateral face (23), has second ball tracks (26) of varying depth in the peripheral direction. The ball tracks (24, 26) define one pair each with opposed slopes and receive one ball (27) each. The adjusting disk (16) is axially supported on the multiple disk clutch (2) and axially and radially mounted by means of the balls (27) retained in the ball tracks (24, 26).

The invention relates to an axial setting device for actuating a multi-plate coupling in the driveline of a motor vehicle. The multi-plate coupling comprises a set of coupling plates which are alternately connected in a rotationally fast and axially displaceable way to the one and the other of two parts rotatable relative to one another, which rest against an axially fixed abutment disc and which can be loaded by an axially displaceable pressure disc. For this purpose, the axial setting device comprises a supporting disc provided with first ball grooves and held in the housing in a rotationally fast way, and a setting disc rotatable relative to said supporting disc and having second ball grooves. The pitches of the first and the second ball grooves are inclined circumferentially in opposite directions, with each two opposed ball grooves forming a pair and accommodating a ball. Because said groove pitches are inclined circumferentially in opposite directions, the rotation of the setting disc relative to the supporting disc causes an axial displacement and thus the actuation of the multi-plate coupling.

From DE 100 33 482 A1, such an axial setting device is already known. It comprise a setting disc rotatingly drivable by an electric motor and a supporting disc connected to the housing in a rotationally fast way. The setting disc is rotatably supported on a hub of the multi-plate coupling by means of a rolling contact bearing and the supporting disc is rotatably supported on a sleeve-shaped projection of the setting disc means of a radial bearing. Between the supporting disc and a pressure ring of the multi-plate coupling, there is provided an axial bearing via which it is possible to transmit an axial displacement between the supporting disc and the setting disc for actuating the multi-plate coupling.

DE 101 29 795 A1 shows a similar axial setting device which comprises two discs which are rotatable relative to one another, which are coaxially supported relative to one another and between which balls are guided in pairs of ball grooves whose depths vary across the circumference. One of the discs is axially supported and the other one is axially displaceable against resilient returning forces of spring means. One of the discs can be driven by a motor via a gear drive, and there are provided spring means which—during the return movement of the discs, after the end position of the balls in the ball grooves has been reached, which end position is represented by the greatest groove depth—permit overshooting of the drivable disc against resilient returning forces of the spring means. The rotatingly drivable disc is supported by a needle bearing on the hub and the fixed disc is slidingly supported on a projection at the rotating disc.

It is the object of the present invention to propose an axial setting device for actuating a multi-plate coupling in the driveline of a motor vehicle which has a simple design and, while having the same functions, comprises a reduced number of parts.

In accordance with the invention, the object is achieved by an axial setting device for actuating a multi-plate coupling in the driveline of a motor vehicle, comprising a housing and a ball ramp assembly centred and arranged on a longitudinal axis and having a supporting disc axially and radially secured in the housing, as well as a setting disc which is axially movable relative to said supporting disc, wherein the supporting disc is rotationally secured in the housing and comprises first ball grooves with a circumferentially variable depth in a first side face, wherein the setting disc which is axially arranged between the supporting disc and the multi-plate coupling is rotatingly drivable and comprises second ball grooves with a circumferentially variable depth in a second side face arranged opposite the first side face, wherein each first and second ball groove form a pair and wherein the ball grooves of each pair comprise pitches being inclined in opposite directions and jointly accommodate a ball, and wherein the setting disc, on one side, is axially supported at least indirectly against the multi-plate coupling and, on the other side, is axially and radially supported by the balls held in the ball grooves.

Said inventive solution is advantageous in that the axial setting device has a simple design because the radial bearings for supporting the setting disc and supporting disc respectively are eliminated. In consequence, the production and assembly procedures are also simplified so that the overall production costs are reduced.

According to a first embodiment, the supporting disc is connected to the housing in a rotationally fast way. With a view to reducing the number of parts, it is particularly advantageous if the supporting disc is produced so as to be integral with the housing, with the ball grooves being formed into the housing. In this way, it is possible to eliminate an additional supporting disc. Alternatively, the supporting disc can be produced separately and, by means of an inner circumferential face, slid on to a sleeve-shaped projection of the housing. According to a further variant, the supporting disc, by means of an outer circumferential face, can be slid into a recess in the housing. Several embodiments are possible for fixing the supporting disc to the housing. Preferably, the supporting disc is connected to the housing in a force-locking way, more particularly by means of a press fit. However, the supporting disc and the housing can also be connected in a form-fitting way, for example by a splined profile, by a serrated profile or a polygonal profile or in a material-locking way, for example by being glued or welded together.

According to an alternative second embodiment, it is proposed that the supporting disc is rotationally movable to a limited extent. More concretely, when moving forward, the setting disc can be used for loading the multi-plate coupling and when moving backwards for releasing the multi-plate coupling, wherein there are provided spring means which—during the return movement of the discs, after the end position of the balls in the ball grooves has been reached, which end position is represented by the greatest groove depth—permit a resilient overshooting of the setting disc together with the supporting disc relative to the housing. The spring means allow the setting disc to rotate further to a limited extent without mechanically overloading the driveline of the setting disc. The rotating masses, when reaching the end stops, can be spring-suspended and preferably braked in a dampened way. In a preferred embodiment, the supporting disc is held in a rotationally secured way between a rotary stop in the housing and the spring means supported in the housing, wherein the supporting disc, when overshooting, abuts against the spring means. The entire oscillation process can be dampened by friction forces resulting from a sliding contact between the supporting disc and the housing.

The spring means can be formed by a helical pressure spring which is arranged tangentially relative to the supporting disc and which cooperates with a cam attached to the supporting disc. According to a further embodiment, the spring means are formed by an elastic rubber or plastic element which is inserted directly into the housing and cooperates with a cam at the setting disc.

Preferred embodiments of the invention will be explained below with reference to the drawings wherein

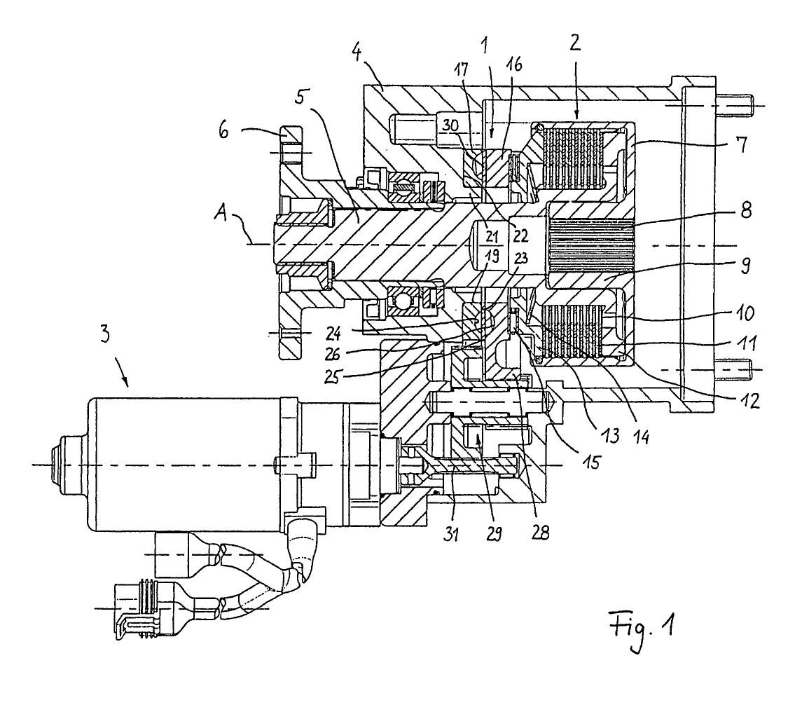

FIG. 1 is a longitudinal section through a first embodiment of an inventive axial setting device with a ball ramp assembly.

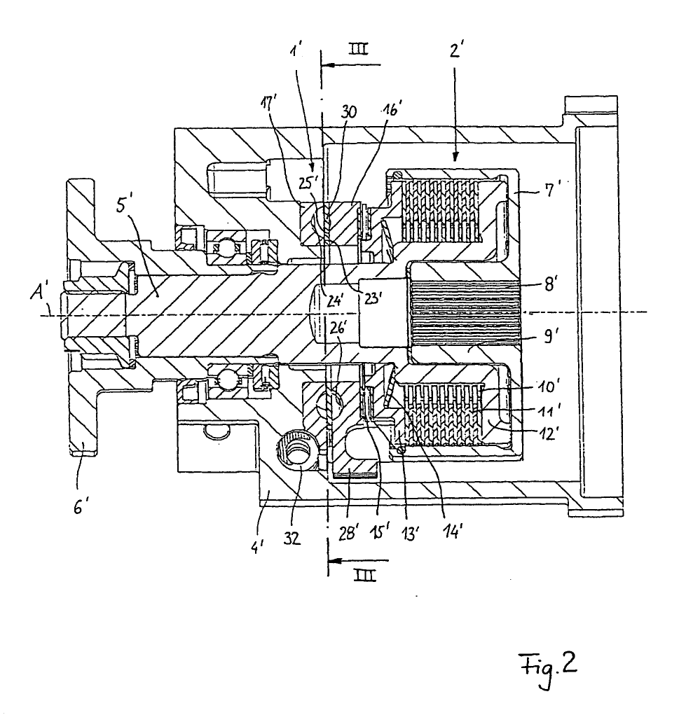

FIG. 2 is a longitudinal section through a second embodiment of an inventive axial setting device, and

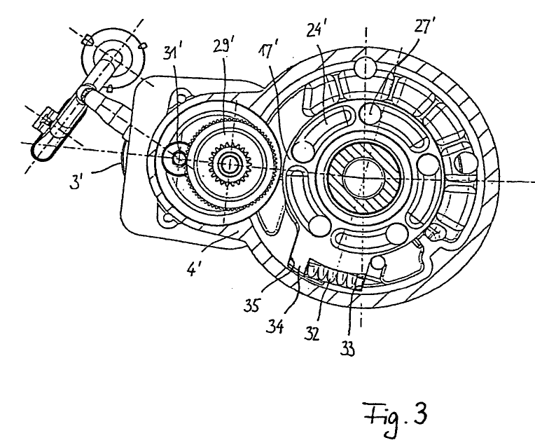

FIG. 3 is a cross-section through the axial setting device according to FIG. 2 along sectional line III-III.

FIG. 1 shows a first embodiment of an inventive axial setting device in a mounted condition. The axial setting device comprises a ball ramp assembly 1 drivable by a motor 3 and intended to actuate a multi-plate coupling 2. The ball ramp assembly 1 and the multi-plate coupling 2 are jointly arranged in a housing 4, with the motor 3 being flanged to said housing 4. The unit shown serves to be used in the driveline of a motor vehicle for optionally connecting a driving axle. For this purpose, the multi-plate coupling 2 comprises a hub 5 with a flange 6 which, for torque transmitting purposes, can be connected to an input shaft (not shown), as well as a carrier 7 with a toothing 8 into which, in a rotationally fast way, a shaft journal can be inserted for driving a differential drive. For supporting purposes, the carrier 7 comprises a hollow journal 9 which rotatably engages a correspondingly designed bore in the hub 5.

The multi-plate coupling 2 which can be set by the ball ramp assembly 1 comprises inner plates 10 and outer plates 11 of which, in a rotationally fast and axially displaceable way, the former being connected to the hub 5 and the latter to the carrier 7. The plates 10, 11 are axially supported on a supporting ring 12 connected to the hub 5 and are axially loaded by a pressure ring 13. The pressure ring 13 is axially supported on the hub 5 via a plate spring 14 and is displaced by an axial bearing 15 which can be loaded by the ball ramp assembly 1. As a result of said axial displacement, the carrier 7, via the plates 10, 11, is coupled to the hub 5 for torque transmitting purposes.

For displacing the axial bearing 15, the ball ramp assembly 1 comprises a setting disc 16 and a supporting disc 17 which axially adjoins same, which are both arranged so as to be centred on a longitudinal axis A. The supporting disc 17 is firmly connected to the housing 4; by means of an inner circumferential face 19 it is pressed on to a sleeve-shaped projection 21 and it is axially supported against a supporting face 22 of the housing 4. In a first side face 23 of the supporting disc 17, which first side face faces the multi-plate coupling 2, there are arranged first ball grooves 24 whose depth varies in the circumferential direction. The setting disc 16 comprises a second side face 25 provided with second ball grooves 26 with a circumferentially variable depth and being positioned opposite the first side face 23 of the supporting disc 17. Each two opposed ball grooves 24, 26 form a pair; the ball grooves 24, 26 of each pair comprise pitches being inclined in circumferentially opposite directions, and jointly accommodate a ball 27. The setting disc 16 which is rotatingly drivable by the motor 3 and is arranged with a radial play relative to the hub 5 is thus supported against the axial bearing 15 at the coupling end and at the flange end, it is axially and radially supported only by the balls 27 held in the ball grooves 24, 26. For being rotatingly driven, the setting disc 16 comprises a tooth segment 28 which is driven via a reduction stage 29 by the driving pinion 31 of the motor 3.

During the forward movement, i.e. when the ball ramp assembly 1 has been given a positive setting by the motor 3, the setting disc 16 is made to rotate, which setting disc 16 is axially displaced by the balls 27 running from deeper ball groove regions to flatter ball groove regions, towards the multi-plate coupling 2 against the returning force of the plate spring 14. During the return movement, i.e. when the ball ramp assembly 1 is returned, the setting disc 16 is rotated backwards by the motor 3 in the opposite direction of rotation until the balls 27 reach the end stops in the ball grooves 24, 26.

FIGS. 2 and 3 which will be described jointly below show a second embodiment of an inventive axial setting device. FIG. 2 does not show the motor and drive because they are positioned in a different sectional plane. The reference numbers of components identical to those shown in FIG. 1 have been provided with an apostrophe. To that extent, reference is made to the previous description.

The embodiment according to FIGS. 2 and 3 differs from the embodiment according to FIG. 1 wherein the supporting disc is firmly inserted into the housing in that the supporting disc 17′ in the housing 4′ is rotatable to a limited extent and, in the direction of rotation, is supported by spring means in the form of a helical pressure spring 32 in the housing 4′. The helical pressure spring 32 is inserted in such a way that, when the end stops of the balls 27′ in the ball grooves 24′, 26′ are reached, it permits a limited amount of rotation of the supporting disc 17′ together with the setting disc 16′. The resulting abrupt braking of the setting disc 16′ is not directly transmitted to the rotor mass of the motor 3′ because the supporting disc 17′, combined with a shortening of the helical pressure spring 32, permits overshooting. In this way, the rotor mass of the motor 3′ and the drive masses are spring-suspended.

It can be seen in FIG. 3 that the helical pressure spring 32 is positioned substantially tangentially relative to the supporting disc 17′ which, together with the ball grooves 24′ and the balls 27′, is shown in a plan view. The helical pressure spring 32, in an anti-clockwise direction, is directly supported on a step 33 in the housing 4′ and, in the clockwise direction, on a cam 34 formed on to the supporting disc 17′. Said cam 34, in turn, rests against a stop 35 in the housing 4′. This means that if a pulse acts on the supporting disc 17′ in an anti-clockwise direction, the cam 34 at the supporting disc 17′ acts on the helical pressure spring 32. As a result, the helical pressure spring 32 is shortened elastically, supporting itself on the step 33 in the housing 4′. Thereafter, the supporting disc 17′ springs back clockwise and, by means of the cam 34, again rests against the stop 35 in the housing 4′ Damping of said oscillation process can be ensured by friction forces between the supporting disc 17′ and the housing 4′.

### LIST OF REFERENCE NUMBERS

1 ball ramp assembly
2 multi-plate coupling
3 motor
4 housing
5 hub
6 flange
7 carrier
8 longitudinal toothing
9 hollow journal
10 inner plates
11 outer plates
12 supporting ring
13 pressure ring
14 plate spring
15 axial bearing
16 setting disc
17 supporting disc
19 inner circumferential face
21 projection
22 supporting face
23 first side face
24 first ball groove
25 second side face
26 second ball groove
27 ball
28 tooth segment
29 reduction stage
31 driving pinion
32 helical pressure spring
33 step
24 cam
25 stop
A longitudinal axis

1. An axial setting device for actuating a multi-plate coupling in the driveline of a motor vehicle, comprising a housing and a ball ramp assembly (1) centered and arranged on a longitudinal axis (A) and having a supporting disc axially and radially secured in the housing, as well as a setting disc which is axially movable relative to said supporting disc,
wherein the supporting disc is rotationally secured in the housing and comprises first ball grooves with a circumferentially variable depth in a first side face,
wherein the setting disc which is axially arranged between the supporting disc and the multi-plate coupling is rotatingly drivable and comprises second ball grooves with a circumferentially variable depth in a second side face arranged opposite the first side face,
wherein each first and second ball groove form a pair and wherein the ball grooves of each pair comprise pitches being inclined in opposite directions and jointly accommodate a ball, and
wherein the setting disc, on one side, is axially supported at least indirectly against the multi-plate coupling and, on the other side, is axially and radially supported by the balls held in the ball grooves.

2.-10. (canceled)
